(19) United States
(12) Patent Application Publication
(10) Pub. No.: US 2025/0340130 A1
(43) Pub. Date: Nov. 6, 2025

(54) METHOD FOR PARKING AN ELECTRIC VEHICLE

(71) Applicant: BOMBARDIER RECREATIONAL PRODUCTS INC., Valcourt (CA)

(72) Inventors: Robin BEAUCHEMIN, St-Denis-de-Brompton (CA); David COURCHESNE, Eastman (CA); Alexandre VACHON, Sherbrooke (CA); Jonathan FORTIER, Lawrenceville (CA)

(21) Appl. No.: 19/198,546

(22) Filed: May 5, 2025

Related U.S. Application Data
(60) Provisional application No. 63/643,080, filed on May 6, 2024.

(51) Int. Cl. B60L 15/20; B60W 10/02; B60W 10/08; B60W 10/10; B60W 30/06

(52) U.S. Cl. CPC B60L 15/2054; B60W 10/02; B60W 10/08; B60W 10/10; B60W 30/06; B60W 2510/1005; B60W 2710/08; B60W 2710/1005

(57) ABSTRACT

A method of parking an electric vehicle and the electric vehicle are disclosed. The electric vehicle includes an electric motor operatively connected to a transmission for propelling the electric vehicle. The method includes selecting a park gear shift position. While an engagement member of the transmission is engaged with an output gear of the transmission, biasing a parking member of the transmission towards a parking gear of the transmission; and engaging the parking member with the parking gear.

### CROSS REFERENCE

The present application claims priority to U.S. Patent Application No. 63/643,080, filed May 6, 2024, which is incorporated herein by reference in its entirety.

### TECHNICAL FIELD

The present technology relates to electric vehicle transmissions, specifically a method for parking an electric vehicle.

### BACKGROUND

During operation of an off-road vehicle, an operator will switch between different gear settings, such as a drive gear (high or low), park, neutral, and/or reverse. In response to selecting any gear setting, the transmission, using one or more shift forks, will selectively engage and/or disengage a disk with a high or low output gear. When the park gear setting is selected, the disk disengages from the output gear while a parking member engages with a parking gear. Off-road vehicles, especially utility oriented off-road vehicles, are typically not driven continuously over long distances and experience frequent stops. This results in the operator frequently shifting the transmission in and out of the park gear setting during regular use of the vehicle. Each time the operator shifts the transmission into or out of the park gear setting, it causes the disk and the output gear to engage and disengage. This continuous engagement and disengagement of the disk with the output gears increases the likelihood of misalignment between the disk and the output gear. This misalignment can reduce vehicle responsiveness and degrade user experience by requiring the operator to physically rock the vehicle back and forth to promote engagement. Additionally, frequent engagement and disengagement of the disk with the output gears leads to further issues, namely wear, which can lead to degradation of the transmission components. In some instances, wear of the transmission components may lead to audible shifting noises or vibration during operation and/or may lead to the disk being unable to properly engage with the output gears or unexpectedly disengage from the output gears during use.

Therefore, there is a desire for a transmission without at least some of the inconveniences described above.

### SUMMARY

It is an object of the present technology to ameliorate at least some of the inconveniences present in the prior art.

According to one aspect of the present technology, there is provided a method for parking an electric vehicle, the electric vehicle including an electric motor operatively connected to a transmission for propelling the electric vehicle, the method including: selecting a park gear shift position; and while an engagement member of the transmission is engaged with an output gear of the transmission: biasing a parking member of the transmission towards a parking gear of the transmission; and engaging the parking member with the parking gear.

In some embodiments, controlling the electric motor, by a motor controller, to stop.

In some embodiments, the engagement member is a disk; the output gear is a high output gear; the transmission also includes a low output gear; and the disk is engaged with the high output gear when biasing the parking member towards the parking gear and engaging the parking member with the parking gear.

In some embodiments, the engagement member is a disk; the output gear is a low output gear; the transmission also includes a high output gear; and the disk is engaged with the low output gear when biasing the parking member towards the parking gear and engaging the parking member with the parking gear.

In some embodiments, the parking member is a parking lever; and biasing the parking member towards the parking gear includes pivoting the parking lever such that an end portion of the parking lever is received in a notch defined by the parking gear.

According to another aspect of the present technology, there is provided a transmission for an electric vehicle, the transmission being operatively connected to and driven by an electric motor, the transmission including: a first biasing member; an output gear operatively connected to the electric motor; an engagement member operatively connected to the first biasing member to be selectively biased towards and engage the output gear; a second biasing member; a parking gear operatively connected to the electric motor; and a parking member operatively connected to the second biasing member to be selectively biased towards and engage the parking gear; and the transmission having a park gear shift position, where: the output gear is engaged with the engagement member; and the parking gear is engaged with the parking member.

In some embodiments, the transmission has an output gear shift position, where: the output gear is engaged with the engagement member; and the parking gear is disengaged from the parking member.

In some embodiments, the output gear is a high output gear; the transmission further includes a low output gear; and the output gear shift position is a high gear shift position.

In some embodiments, the output gear is a low output gear; the transmission further includes a high output gear; and the output gear shift position is a low gear shift position.

In some embodiments, the output gear is a first output gear; the output gear shift position is a first output gear shift position; the transmission further includes: a second output gear operatively connected to the electric motor; and the engagement member is configured to selectively engage the second output gear.

In some embodiments, a shift drum having a surface defining a groove therein, the groove having: a first section and a second section, the first section being axially offset from the second section, and the first section having: a first output gear portion corresponding to the first output gear shift position of the transmission, and a park portion corresponding to the park gear shift position of the transmission; and the first biasing member being operatively connected to the groove.

In some embodiments, the first output gear portion and the park portion are adjacent to one another within the first section.

In some embodiments, the transmission has a second output gear shift position, where: the second output gear is engaged with the engagement member; the first output gear is disengaged from the engagement member; and the parking gear is disengaged from the parking member.

In some embodiments, the second section of the groove has a second output gear portion corresponding to the second output gear shift position of the transmission.

In some embodiments, the first output gear is a high output gear; the first output gear shift position is a high output gear shift position; the first output gear portion is a high output gear portion; the second output gear is a low output gear; the second output gear shift position is a low output gear shift position; and the second output gear portion is a low output gear portion.

In some embodiments, the first output gear is a low output gear; the first output gear shift position is a low output gear shift position; the first output gear portion is a low output gear portion; the second output gear is a high output gear; the second output gear shift position is a high output gear shift position; and the second output gear portion is a high output gear portion.

In some embodiments, the groove has a third section extending between the first and the second sections, the third section being axially offset from the first and the second sections.

In some embodiments, the third section has a neutral portion, corresponding to a neutral shift position of the transmission, where: the second output gear is disengaged from the engagement member; the first output gear is disengaged from the engagement member; and the parking gear is disengaged from the parking member.

According to another aspect of the present technology, electric vehicle comprising: an electric motor; a transmission operatively connected to and driven by the electric motor, the transmission having: a first biasing member; an output gear operatively connected to the electric motor; an engagement member operatively connected to the first biasing member to be selectively biased towards and engage the output gear; a second biasing member; a parking gear operatively connected to the electric motor; and a parking member operatively connected to the second biasing member to be selectively biased towards and engage the parking gear; and the transmission having a park gear shift position, where: the output gear is engaged with the engagement member; and the parking gear is engaged with the parking member; a driveshaft operatively connected to and driven by the electric motor via the transmission; and at least one ground engaging member operatively connected to and driven by the drive shaft.

In some embodiments, the electric vehicle further includes a motor controller in communication with the electric motor and configured to stop the electric motor in response to the transmission being in the park gear shift position.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application.

As used herein, the term “about” in the context of a given value or range refers to a value or range that is within 20%, preferably within 10%, and more preferably within 5% of the given value or range.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle;

FIG. 2 is perspective view taken from a front, right side of a transmission and a transaxle assembly of the vehicle of FIG. 1;

FIG. 3 is a perspective view taken from a front, left side of the transmission and the transaxle assembly of FIG. 2, with a portion of a transmission housing having been removed;

FIG. 4 is a perspective view taken from a front, right side of the components of FIG. 3;

FIG. 5 is an exploded view of portions of the transmission of FIG. 3;

FIG. 6 is a perspective view taken from a front, right side of a disk of the transmission of FIG. 3;

FIG. 7 is a perspective view taken from a rear, right side of the disk and a low output gear of the transmission of FIG. 3;

FIG. 8 is a perspective view taken from a front, left side of portions of the transmission of FIG. 3;

FIG. 9 is a perspective view taken from a front, right side of portions of the transmission of FIG. 3;

FIG. 10 is an illustration of grooves of a shift drum of the transmission of FIG. 3;

FIG. 11 is a cross-sectional view of the transmission of FIG. 3, taken along line 11-11 of FIG. 4, with the transmission being in the neutral shift position;

FIG. 12 is a cross-sectional view of the transmission of FIG. 3 taken along the line 11-11, with the transmission in the low gear shift position;

FIG. 13 is a cross-sectional view of the transmission of FIG. 3 taken along the line 11-11, with the transmission in the high gear shift position;

FIG. 14 is a cross-sectional view of the transmission of FIG. 3 taken along the line 11-11, depicting misalignment of the disk and gear engaging and receiving portions, during attempted engagement of the high gear shift position of the transmission;

FIG. 15 is a front elevation view of portions of the transmission of FIG. 3, with a parking assembly in an engaged position;

FIG. 16 is a flow diagram depicting a method for engaging an output gear of the transmission of the vehicle of FIG. 1;

FIG. 17 is a flow diagram depicting a method for engaging a parking gear of the transmission of the vehicle of FIG. 1;

FIG. 18 is a flow diagram depicting a method for disengaging an output gear of the transmission of the vehicle of FIG. 1;

FIG. 19 is a flow diagram depicting a method for disengaging the parking gear of the transmission of the vehicle of FIG. 1;

FIG. 20 depicts a perspective view taken from a rear, top side of a gear shift lever and a shift gate of the vehicle of FIG. 1;

FIG. 21 depicts an illustration of grooves of an alternative embodiment of a shift drum of a transmission; and

FIG. 22 depicts a method for parking the vehicle of FIG. 1 with the shift drum of FIG. 10.

It should be noted that the Figures are not necessarily drawn to scale.

### DETAILED DESCRIPTION

The present technology is described with reference to its use in an off-road side-by-side vehicle (SSV). It is contemplated that the present technology could be implemented in different vehicles, including but not limited to all-terrain vehicles (ATVs), automobiles, other off-road vehicles, snowmobiles, and karts.

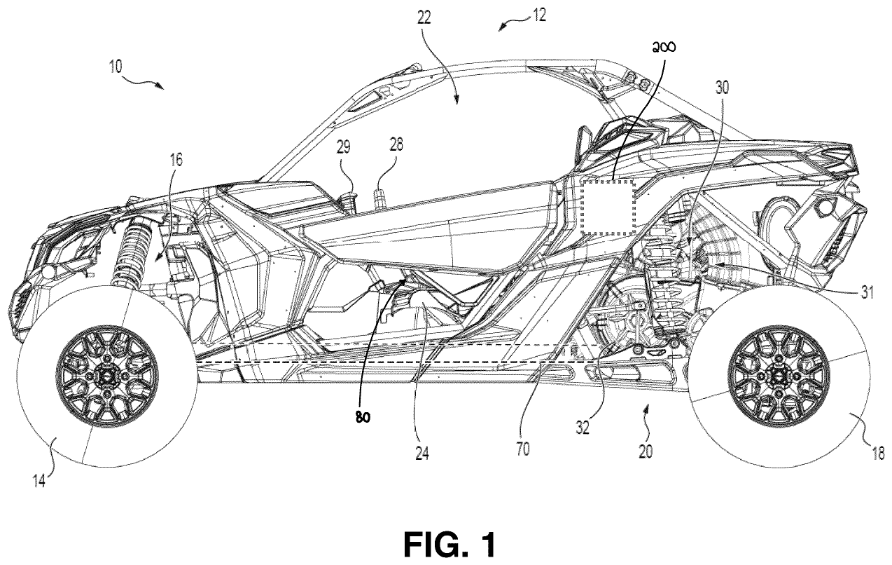

The general features of a side-by-side vehicle (SSV) 10 will be described with respect to FIG. 1 as one non-limiting application of the present technology.

The vehicle 10 has a frame 12, two front wheels 14 connected to a front of the frame 12 by front suspension assemblies 16 and two rear wheels 18 connected to the frame 12 by rear suspension assemblies 20.

The frame 12 defines a central cockpit area 22 inside which are disposed a driver seat 24 and a passenger seat (not shown). A roll cage 17 defines a top side of the cockpit area 22. In the present embodiment, the driver seat 24 is disposed on the left side of the vehicle 10 and the passenger seat is disposed on the right side of the vehicle 10. However, it is contemplated that the driver seat 24 could be disposed on the right side of the vehicle 10 and that the passenger seat could be disposed on the left side of the vehicle 10.

A steering wheel 28 is disposed in front of the driver seat 24. The steering wheel 28 is used to turn the front wheels 14 to steer the vehicle 10. Various displays and gauges 29 are disposed above the steering wheel 28 to provide information to the driver regarding the operating conditions of the vehicle 10. Examples of displays and gauges 29 include, but are not limited to, a speedometer, a tachometer, and a transmission position display.

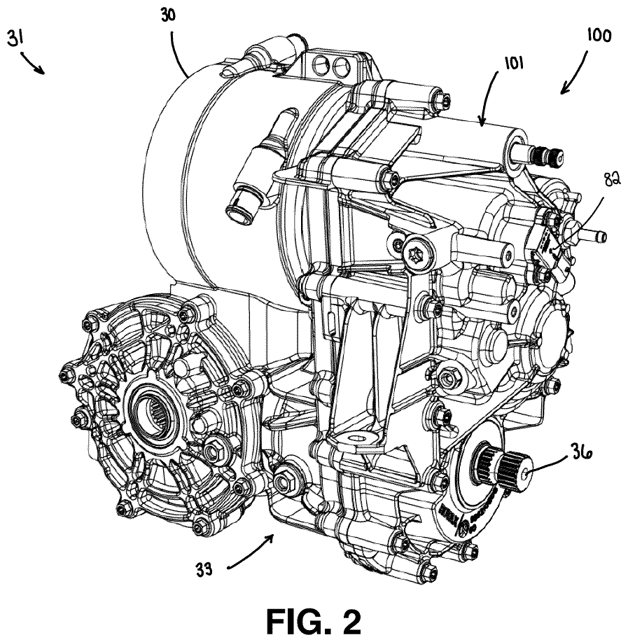

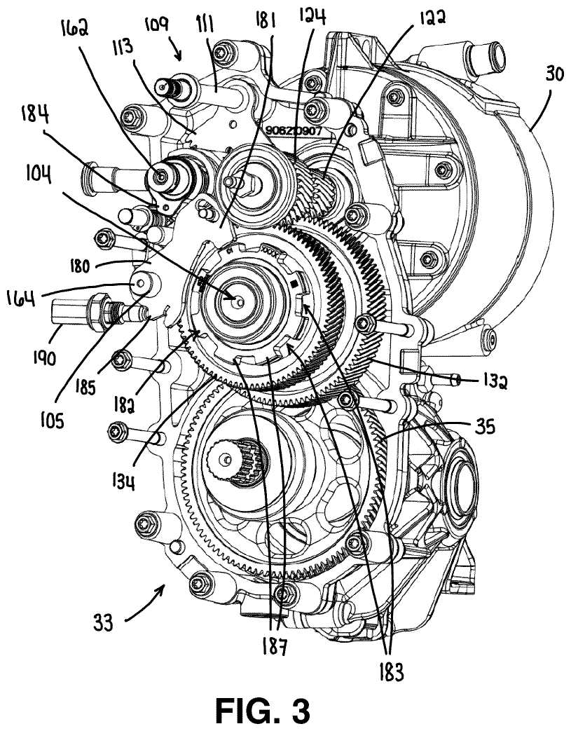

With additional reference to FIGS. 2 and 3, the vehicle 10 further includes a motor assembly 31, which includes an electric motor 30 (hereinafter a motor 30), a transmission 100 connected to and driven by the motor 30, a transaxle assembly 33 connected to the transmission 100, and a motor controller 200 (shown schematically in FIG. 1) in communication with the motor 30. The motor assembly 31 is connected to the frame 12 in a rear portion of the vehicle 10. The transmission 100 and the motor controller 200 will be described in more detail below.

The motor 30 is operatively connected to the driveshaft 70 (shown schematically in FIG. 1) via the transmission 100 to transmit torque from the motor 30. The driveshaft 70 includes a front driveshaft and a rear driveshaft (not numbered), operatively connected to front and rear wheels 14, 18 to propel the vehicle 10.

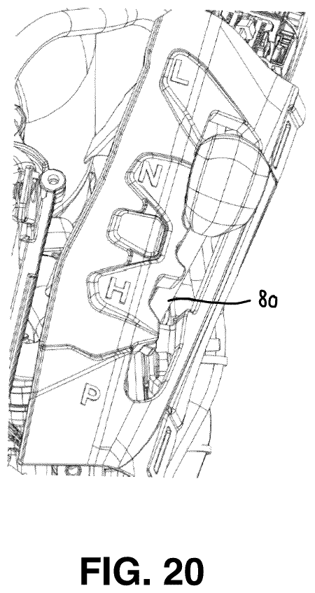

The transmission 100 is disposed in front of the motor 30 and controls the transfer of torque from the motor 30 to the driveshaft 70 through several shift positions. According to the present technology, the transmission 100 can be selectively arranged to control the transfer of torque through a low gear shift position and a high gear shift position. The transmission 100 includes a high reverse gear shift position in which the transmission 100 is arranged in the high gear shift position and the motor 30 turns in the opposite direction. Similarly, the transmission 100 includes a low reverse gear shift position in which the transmission 100 is arranged in the low gear shift position and the motor 30 turns in the opposite direction. The transmission 100 also includes a neutral shift position where no torque is transferred, and a park shift position where no torque is transferred and motion of the driveshaft 70 is impeded. The respective shift positions are controlled by an operator moving a gear shift lever 80 (depicted in FIG. 20) to the respective position. In this embodiment, a gear shift position sensor 82 (depicted in FIG. 2) is connected to a shift drum 110 of the transmission 100 and detects the position of the gear shift lever 80 when the operator shifts gear shift positions. Specifically, the gear shift position sensor 82 detects the rotary position of the shift drum 110 (described in further detail below). The gear shift position sensor 82 is in communication with the motor controller 200. It is contemplated that the gear shift position sensor 82 may be positioned and connected differently in other embodiments. It is contemplated that, in other embodiments, the operator may select the gear shift position via a user interface disposed on the vehicle 10.

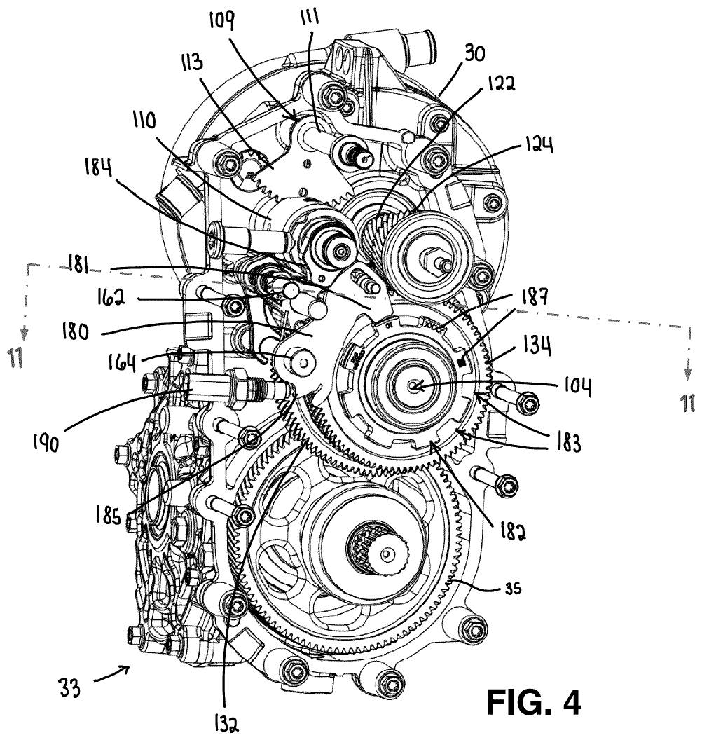

FIGS. 3 to 15 depict the different components of the transmission 100 will now be described in detail. While the transmission 100 is disposed in a transmission housing 101, as seen in FIG. 2, the housing 101 has been removed, for example in FIGS. 3 and 4 to better illustrate the components of the transmission 100.

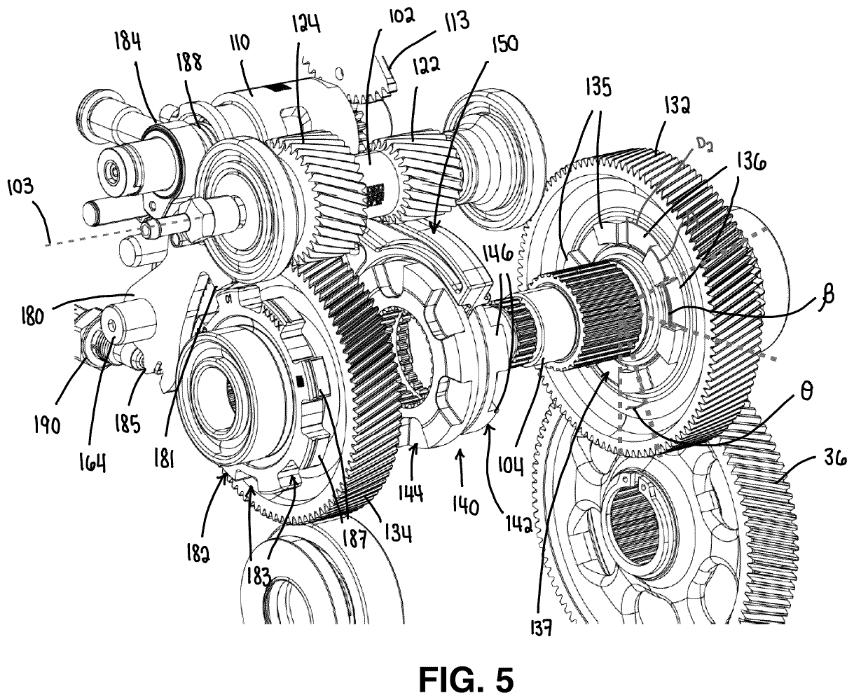

As depicted in FIG. 5, the transmission 100 includes an input shaft 102 operatively connected to the motor 30 for receiving torque therefrom. The input shaft 102 rotates about an input axis 103. The input shaft 102 extends generally longitudinally forward of the motor 30.

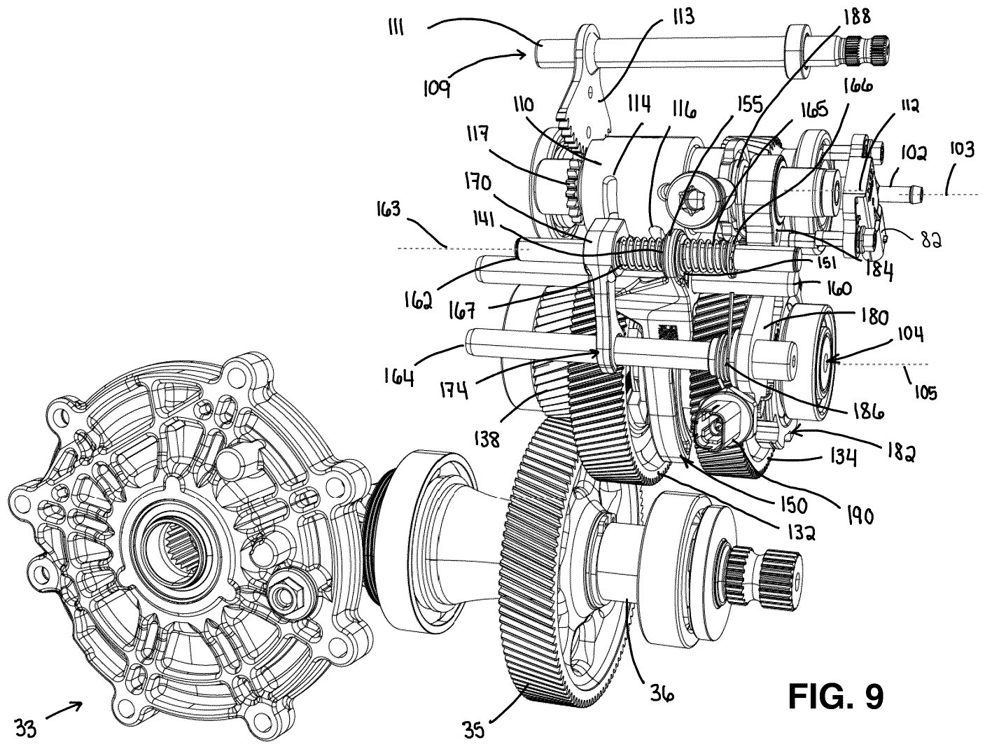

The transmission 100 includes an output shaft 104 operatively connected to the driveshaft 70 for transferring torque from the transmission 100 to the driveshaft 70 to drive the wheels 14, 18. Specifically, as depicted in FIG. 9, torque is transferred via a terminal output gear 138 disposed on the output shaft 104. The terminal output gear 138 is operatively connected to the driveshaft 70 via the transaxle assembly 33. The terminal output gear 138 is engaged with a final drive gear 35 of the transaxle assembly 33. The final drive gear 35 is rotationally fixed to a pinion shaft 36. Rotation of the pinion shaft 36 drives the transaxle assembly 33 for driving the rear wheels. Rotation of the pinion shaft 36 rotates the driveshaft 70. Thus, torque is transferred from the output shaft 104 to the driveshaft 70. The output shaft 104 rotates about an output axis 105, arranged parallel to the input axis 103. Both rotation axes 103, 105 extend longitudinally in the vehicle 10, although this may not be the case in all embodiments of the vehicle 10.

The input shaft 102 is operatively connected to the output shaft 104 via a low input gear 122 and a high input gear 124 which selectively transfers torque to the output shaft 104. The low and high input gears 122, 124 are rotationally fixed with respect to the input shaft 102, such that rotation of the input shaft 102 rotates the low and high input gears 122, 124 about the input axis 103.

The output shaft 104 includes a low output gear 132 and a high output gear 134 engaged with the input gears 122, 124. Specifically, the low output gear 132 is engaged with the low input gear 122, such that rotation of the low input gear 122 via rotation of the input shaft 102 causes rotation of the low output gear 132. Similarly, the high output gear 134 is engaged with the high input gear 124, such that rotation of the high input gear 124 via rotation of the input shaft 102 causes rotation of the high output gear 134. When the transmission 100 is arranged in the neutral shift position, the output gears 132, 134 freely rotate with respect to the output shaft 104.

The output shaft 104 further includes a disk 140 axially translatable with respect to the output shaft 104. The disk 104 selectively engages the output gears 132, 134 to couple the output gears 132, 134 to the output shaft 104. The disk 140 is rotationally fixed with respect to the output shaft 104 via splines. As such, upon coupling with one of the output gears 132, 134, rotation of the disk 140 causes rotation of the output shaft 104 at the speed of the coupled output gear 132 or 134. The disk 140 includes a groove 139 defined along an outer surface of the disk 140 for receiving a portion of a shift fork 150, which will be described in further detail below.

With specific reference to FIGS. 5 to 7, the disk 140 will be described in further detail. In this embodiment, the disk 140 includes a low gear engaging portion 142 and a high gear engaging portion 144 disposed on opposite sides of the disk 140. The low gear engaging portion 142 is disposed on a surface 143 of the disk 140 facing the low output gear 132 and selectively engages the low output gear 132. Similarly, the high gear engaging portion 144 is disposed on a surface 145 of the disk 140 facing the high output gear 134 and selectively engages the high output gear 134. In this embodiment, both the low gear engaging portion 142 and the high gear engaging portion 144 share similar configurations. Therefore, for clarity, only the low gear engaging portion 142 will be described in further detail.

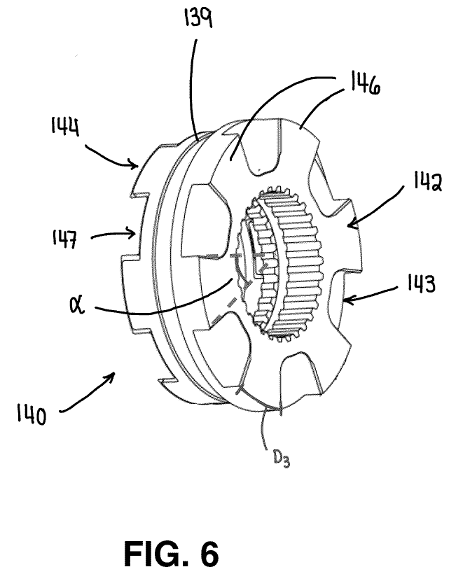

The low gear engaging portion 142 of the disk 140 includes a plurality of projections 146 extending axially away from the surface 143 of the disk 140. The projections 146 are disposed in a circle on the surface 143. Each projection 146 spans a central angle (denoted by α in FIG. 6) and is configured to be received by a receiving portion 131 of the low output gear 132, which will be described in further detail below. In this embodiment, the projections 146 are disposed equicircumferentially around the surface 143 of the disk 140. That is, the projections 146 are spaced equidistant from each other around the circle. In some embodiments, the central angle is about 30°.

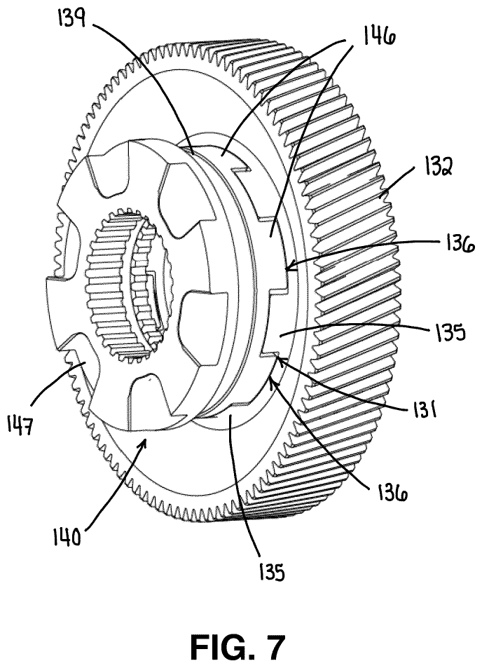

As depicted in FIGS. 5 and 7, the low output gear 132 includes a plurality of projections 135 extending axially away from a surface 137 of the low output gear 132. Each projection 135 spans a central angle (denoted by θ in FIG. 5). The projections 135 are disposed in a circle around the surface 137 and define a plurality of notches 136 therebetween. The notches 136 are equal in size to the projections 135. That is, the notches 136 span a central angle (denoted by β in FIG. 5) which is equal to the central angle of the projections 135. Each notch 136 is configured to receive a projection 146 of the disk 140, forming the receiving portion 131 of the low output gear 132. The notches 136 are dimensioned to accommodate the projections 146, with little play between the projections 135, 146 when the projections 146 are received in the notches 136. By translating the disk 140 towards the low output gear 132, each projection 146 is received into a corresponding notch 136 to engage the disk 140 and the low output gear 132 and rotationally link the output shaft 104 with the low output gear 132 causing rotation of the output shaft 104. It is contemplated that in other embodiments, the projections 135 and the notches 136 may not be equal in size, and thus the central angle of the projections 135 may not be equal to the central angle of the notches 136. It is noted that in other embodiments, the projections 146, 135 and notches 136 may be described in terms of their respective arc lengths. For example in some embodiments, the projections 135 may have an arc length (denoted by D₁ in FIG. 5), the notches 136 may have an arc length (denoted by D₂ in FIG. 5) and the projections 146 may have an arc length (denoted by D₃ in FIG. 6).

In this embodiment, the high output gear 134 includes a receiving portion (not shown) that has an identical configuration to that of the receiving portion 131 of the low output gear 132 and, thus, will not be described in further detail.

While only one disk 140 is shown, in other embodiments, multiple disks could be used, with each disk engaging either the low output gear 132 or the high output gear 134.

It is contemplated that, in alternative embodiments, the disk 140 may be positioned on the input shaft 102 to engage the low and high input gears 122, 124. In this instance, the low and high input gears 122, 124 would be rotationally independent from the input shaft 102 while the low and high output gears 132, 134 would be rotationally fixed to the output shaft 104. The low and high input gears 122, 124 would each include a respective receiving portion to receive the projections 146 of the disk 140 as described above.

With reference to FIGS. 5, 8, and 9, the transmission 100 further includes a shift fork 150 for controlling the axial translation of the disk 140 along the output shaft 104 towards either the low output gear 132 or the high output gear 134. The shift fork 150 is connected to the disk 140. The shift fork 150 includes two curved prongs partially disposed around the disk 140 (see FIG. 7). The two curved prongs are received in the groove 139 of the disk 140 to enable movement of the disk 140 along the output shaft 104 (in response to movement of the shift fork 150) without affecting the rotational motion of the disk 140. Although only one shift fork 150 is depicted, in some embodiments, multiple shift forks may be used.

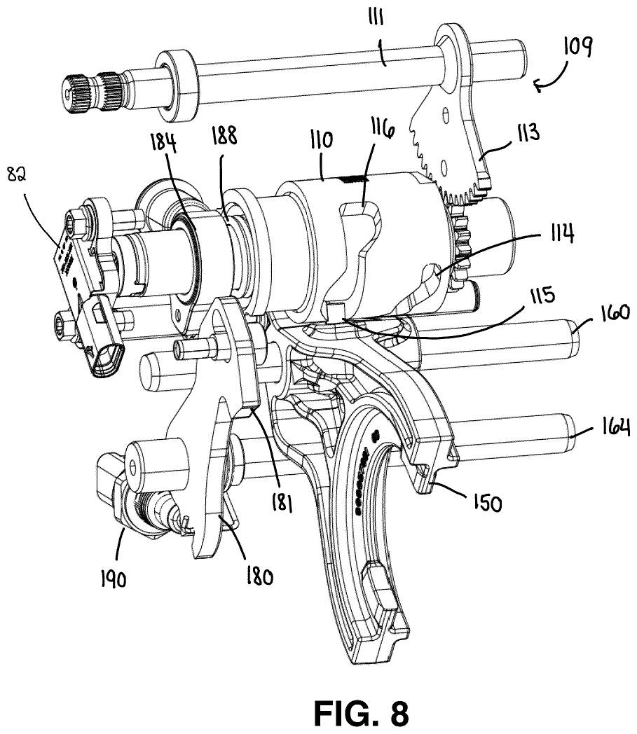

The shift fork 150 is supported by and slidably connected to a fork rod 160. As seen in FIGS. 8 and 9, the fork rod 160 extends through an aperture of the shift fork 150. The fork rod 160 extends parallel to the input and output shaft axes 103, 105.

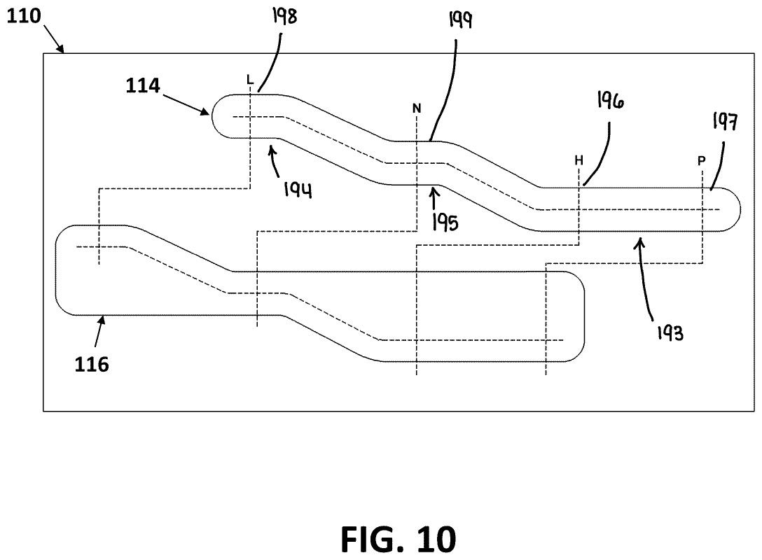

To selectively control torque transfer from the input shaft 102 to the output shaft 104, the transmission 100 includes a shift drum 110 rotatable about a shift drum axis 112 (as seen in FIG. 9). The shift drum 110 defines two grooves 114, 116 in its surface. The paths of the grooves 114, 116 are depicted in FIG. 10, with the surface of the shift drum 110 being unwrapped to a flat rectangle. The shift drum 110 operatively connects to the shift fork 150 to control the lateral movement of the shift fork 150 which, in turn, controls the lateral movement of the disk 140. Specifically, as shown in FIG. 8, the groove 116 receives a protrusion 115 of the shift fork 150, operatively connecting the shift fork 150 to the shift drum 110. The shift drum 110 operatively connects to a shift rod 162 to control the lateral movement of the shift rod 162 (as will be discussed in detail below).

The shift fork 150 is further slidably connected to the shift rod 162 which extends parallel to the fork rod 160. The shift fork 150 includes a follower 155 which is slidably disposed around the shift rod 162.

As discussed above, lateral movement of the shift rod 162 is controlled by the shift drum 110. Specifically, a driving member 170 (as seen in FIG. 9) is received in the groove 114 of the shift drum 110, operatively connecting the shift rod 162 to the shift drum 110. The driving member 170 is fixedly connected by interference fitting to the shift rod 162, such that lateral movement of the driving member 170 causes lateral movement of the shift rod 162 along the rod axis 163. The driving member 170 includes an aperture through which the shift rod 162 extends.

The driving member 170 is slidably engaged with a support rod 164 disposed and extending parallel to the fork rod 160 and the shift rod 162. Specifically, the driving member 170 includes a fork portion 174 which partially surrounds the support rod 164 and slidably connects with the support rod 164 to prevent the driving member 170 and the shift rod 162 from rotating about the shift rod axis 163 during operation while allowing the driving member 170 to laterally translate with respect to the support rod 164. In some embodiments, the support rod 164 may be omitted.

With reference to FIGS. 9, and 11 to 14, the shift rod 162 has two biasing members 165, 167 disposed thereon. In this embodiment, the biasing members 165, 167 are springs 165, 167 which work cooperatively with the shift drum 110 to selectively translate the shift fork 150 and the disk 140. In the present embodiment, the springs 165, 167 have equal stiffnesses. It is contemplated that the springs 165, 167 could have different stiffnesses, depending on specific details of the particular embodiment.

Spring 165 has one end which remains immobile relative to the shift rod 162 during use. Specifically, one end of the spring 165 abuts a washer 166 which is held in place relative to the shift rod 162 between the end of the spring 165 and a retaining ring which is fixed to the shift rod 162. In some embodiments, one end of the spring 165 could be connected directly to the shift rod 162. The follower 155 of the shift fork 150 abuts the opposite end of the spring 165 via a washer 151.

Spring 167 is disposed between the follower 155 of the shift fork 150 and the driving member 170. As such, the springs 165, 167 are disposed on opposite sides of the follower 155 of the shift fork 150. The shift fork 150 abuts one end of the spring 167 via a washer 149 and the driving member 170 abuts the opposite end of the spring 167.

As depicted in FIGS. 3, 4, and 15, the transmission 100 includes components for a park shift position to prevent motion of the vehicle 10. The park shift position is specifically arranged to impede rotation of the output shaft 104. To hold the output shaft 104 in position, the transmission 100 includes a parking member 180 that selectively engages with a parking gear 182 on the output shaft 104. In this embodiment, the parking member 180 is a parking lever 180 having an end portion 181 that is received by a receiving portion 183 of the parking gear 182 to engage the parking lever 180 with the parking gear 182, as will be described in further detail below. It is contemplated that the parking member 180 may have a different configuration for engaging the parking gear 182 in different embodiments.

The parking lever 180 is rotatably connected to the support rod 164. In some embodiments, it is contemplated that the parking lever 180 could be connected to another one of the fork rod 160 and the shift rod 182. It is also contemplated that the parking lever 180 could be connected to other components of the transmission 100.

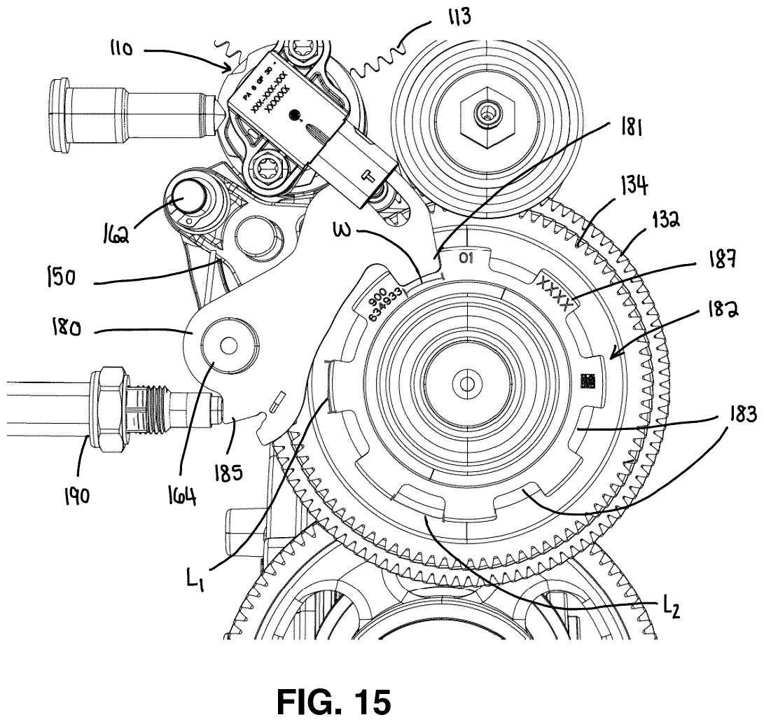

As discussed above, the parking gear 182 includes a receiving portion 183 to receive the end portion 181 of the parking lever 180. Specifically, the receiving portion 183 of the parking gear 182 is a plurality of notches 183 defined between a plurality of radial teeth 187. Each tooth 187 spans an arc length (denoted by L₁ in FIG. 15) and are uniformly spaced around an outer edge of the parking gear 182. The notches 183 are equal in size to the teeth 187. That is, the notches 183 span an arch length (denoted by L₂ in FIG. 15) that is equal to the arc length of the teeth 187, but it is contemplated that their relative sizes may be different, in different embodiments. The notches 183 are sized to receive the end portion 181 of the parking lever 180. The notches 183 are dimensioned to accommodate the end portion 181, with little play between the end portion 181 and the teeth 187 when the end portion 181 is received in the notch 183. The parking gear 182 is rotationally fixed with respect to the output shaft 104, such that when the parking gear 182 and the parking lever 180 are engaged (preventing rotation of the parking gear 180), the output shaft 104 is prevented from rotating. It is contemplated that the receiving portion 183 of the parking gear 182 may have a different configuration in other embodiments, for example the receiving portion 183 may include recesses or channels defined in a surface of the parking gear 182 and disposed circumferentially around the parking gear 182.

The parking lever 180 is pivotable between at least a disengaged position (FIGS. 3 and 4) and an engaged position (FIG. 15). In the disengaged position, the parking lever 180 does not contact any components on the output shaft 104 (including the parking gear 182) such that the output shaft 104 can freely rotate according to the specific shift position of the transmission 100. In the engaged position, the parking lever 180 is rotated toward the parking gear 182, such that the end portion 181 is received in one of the notches 183. With the parking lever 180 inserted into one of the notches 183, the parking gear 182 is prevented from rotating, which in turn prevents rotation of the output shaft 104.

In order to selectively rotate the parking lever 180 toward the parking gear 182, the transmission 100 also includes a parking cam 184 connected to the shift drum 110. As the shift drum 110 is selectively rotated to the park shift position of the shift drum 110, the parking cam 184 is rotated to push the parking lever 180 into engagement with the parking gear 182 to prevent rotation of the output shaft 104. A biasing member 188, such as spring 188 (FIG. 8), is included, the spring 188 is connected between the shift drum 110 and the parking cam 184. Biasing member 188 allows the park shift position to be selected by the operator, thus rotating the shift drum 110, even in cases of misalignment, resulting from non-engagement between the parking gear notches 183 and the parking lever 180. Biasing member 188 becomes under tension when the shift drum 110 rotates and the parking cam 184 cannot rotate, due to the misalignment between parking gear notches 183 and the parking lever 180, which prevents the parking lever 180 from moving. In cases of misalignment, the biasing member 188 which is under tension, biases the parking cam 184, which in turn biases the parking lever 180 towards the parking gear 182. Once the misalignment is resolved, due to a slight rotation of the parking gear 182, parking gear notches 183 and parking lever 180 become aligned, allowing the movement of parking lever 180 into one of the parking gear notches 183. If parking gear notches 183 and parking lever 180 are initially aligned, the parking cam 184 rotates with the shift drum 110 to axially bias the parking lever 180 towards the parking gear 182.

To prevent the parking lever 180 from engaging with the parking gear 182 when the transmission is not in the park shift position and allow parking lever 180 to disengage from the parking gear 182, when the vehicle is shifted out of the park shift position, a biasing member 186 biases the end portion 181 of the parking lever 180 away from the parking gear 182 (as seen in FIG. 9). In this embodiment, the biasing member 186 is a spring 186 disposed around the support rod 164 and is connected between the fork rod 160 and the parking lever 180. It should be noted that biasing member 188 exerts sufficient force on the parking cam 184, which in turn exerts this force on the parking lever 180, to overcome the opposing force exerted by biasing member 186 on parking lever 180.

The transmission 100 also includes a parking lock sensor 190, for detecting when the parking lever 180 is engaged with the parking gear 182. Specifically, the parking lock sensor 190 detects the position of the parking lever 180. The parking lock sensor 190 is selectively triggered by a protrusion 185 of the parking lever 180 (see FIG. 15) when the end portion 181 of the parking lever 180 is engaged with the parking gear 182. It is contemplated that the sensor 190 could be differently arranged with respect to the parking lever 180 and/or the gear 182. The parking lock sensor 190 is in communication with the motor controller 200.

With reference to FIGS. 10 to 14, 21, and 22, operation of the shift drum 110 and the transmission 100 will now be described in more detail.

The shift drum 110 selectively causes the transmission 100 to be arranged in one the following shift positions: the park shift position (identified as P in FIG. 10), a high gear shift position (H), a neutral shift position (N), and a low gear shift position (L). The identified positions in FIG. 10 correspond to the location of the protrusion 115 of the shift fork 150, 152 in groove 116 and the protrusion of the driving member 170 in the groove 114 at each of the different shift positions. The shift positions are illustrated in sequential rotational order on the shift drum 110. It is noted that, in the present embodiment, in the park shift position (P), the transmission 100 passes through the high gear shift position (H) such that the disk 140 remains engaged with the high output gear 134 when in the park shift position (P).

The groove 114 has three sections 193, 194, 195 with each section being axially offset from one another. The section 193 includes a high output gear portion 196 corresponding to the high gear shift position (H) of the transmission 100 and a high gear rotational position of the shift drum 110. The section 193 further includes the park portion 197 corresponding to the park gear shift position (P) of the transmission 100 and a park rotational position of the shift drum 110. The high output gear portion 196 and the park portion 197 are adjacent to and axially aligned with one another, such that when the transmission 100 is in the park gear shift position (P), the high output gear 132 is engaged with the disk 140. The section 194 of the groove 114 is axially offset from the section 193. The section 194 includes a low output gear portion 198 corresponding to the low output gear shift position (L) of the transmission 100 and a low gear rotational position of the shift drum 110. The section 195 extends between the sections 193, 194. The section 195 is axially offset from the sections 193, 194. In this embodiment, the section 195 is centrally positioned, axially, between the sections 193, the section 195 includes a neutral gear portion 199 corresponding to the neutral shift position (N) of the transmission and the neutral rotational position of the shift drum 110.

At various positions, groove 116 includes wider portions (wider than at least one other portion of the groove 116) which allow for some freedom of movement of the shift fork 150, as will be described in more detail below. As the protrusion 175 of the driving member 170 is offset from the protrusions of the shift forks 150, groove 114 is circumferentially offset from groove 116.

In order to move the shift fork 150 and the driving member 170 along the grooves 114, 116 to change shift position of the transmission 100, the shift drum 110 rotates about the drum axis 112. Rotation of the shift drum 110 is controlled by a shift assembly 109 operatively connected to the gear selector lever 80 in the vehicle 10. The shift assembly 109 pivots to selectively rotate the shift drum 110 according to the position to which the gear selector lever 80 is moved by the operator of the vehicle 10. The shift assembly 109 includes a partial gear 113 rotationally fixed to a selector shaft 111. The partial gear 113 is engaged with a shift drum gear 117. When the operator moves the gear selector lever 80, the selector shaft 111 pivots the partial gear 113 to rotate the shift drum gear 117, rotating the shift drum 110 about the shift drum axis 112.

Prior to selecting the gear shift position, the operator must first stop the vehicle 10. The operator then moves the gear selector lever 80 to the desired gear shift position.

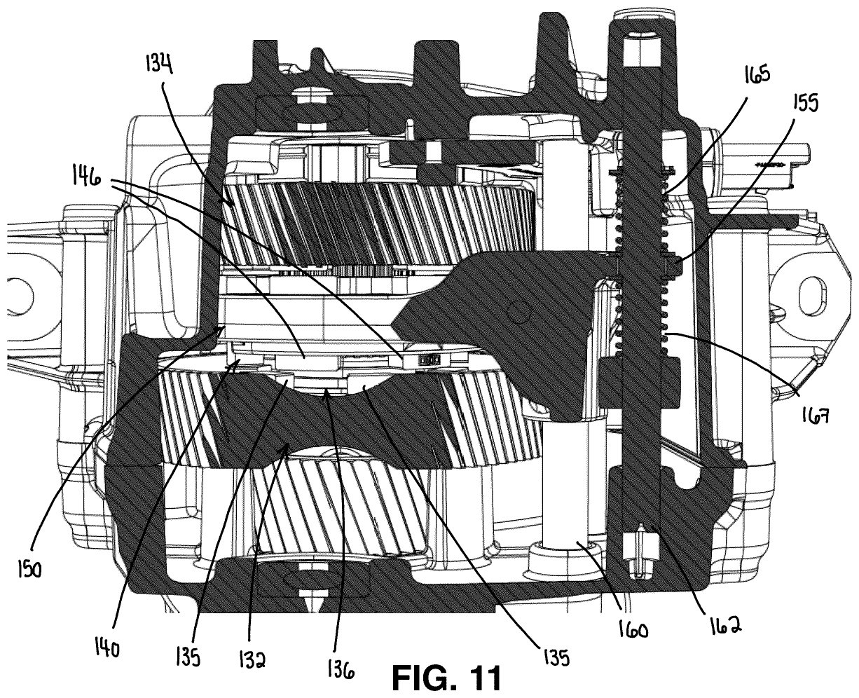

When the operator chooses the neutral shift position with the gear selector lever 80, the shift drum 110 is rotated to a neutral rotational position. The transmission 100 is arranged in the neutral shift position in FIG. 11. The shift rod 162 is translated to a central shift rod position along the rod axis 163 by the driving member 170, where the shift rod 162 is disposed midway between its extreme positions. In the neutral shift position, the disk 140 is disengaged from both the low output gear 132 and the high output gear 134, and the parking lever 180 is disengaged from the parking gear 182. As such, substantially no torque is transferred between the input shaft 102 and the output shaft 104.

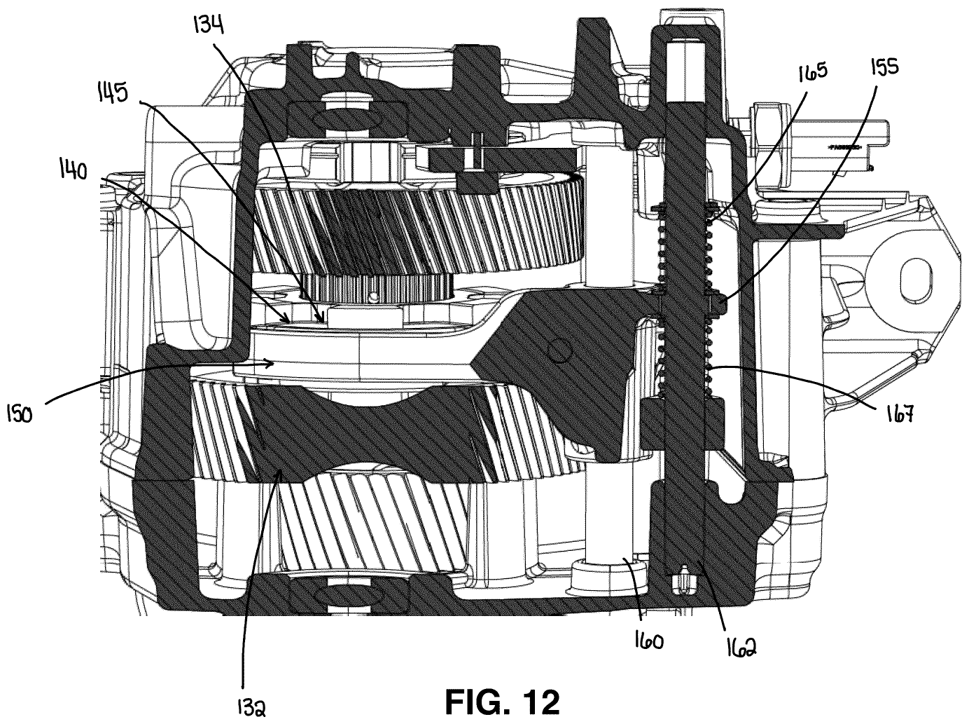

When the operator chooses the low gear shift position with the gear selector lever 80, the shift drum 110 is rotated to a low gear rotational position. The transmission 100 is arranged in the low gear shift position in FIG. 12. The shift rod 162 is translated to a rear shift rod position along the rod axis 163 by the driving member 170 (as moved by the groove 114). In the rear rod shift position, the shift rod 162 is translated to a rearmost position. The groove 116 has a wider portion at the low gear rotational position, such that the shift fork 150 can move rearward while not being forced rearward.

When the projections 146 of the disk 140 and the notches 136 of the low output gear 132 are rotationally aligned, the spring 165 pushes the disk 140 via the shift fork 150 into engagement with the low output gear 132, engaging the disk 140 with the low output gear 132. In the low gear shift position, the high output gear 134 is disengaged from the disk 140 and the parking lever 180 is disengaged from the parking gear 182. Thus, the transmission 100 transfers torque between the input shaft 102 and the output shaft 104 via the low input gear 122 and the low output gear 132. As suggested by the name, the low gear shift position is arranged and structured to produce a ratio of a speed of rotation of the output shaft 104 to a speed of rotation of the input shaft 102 that is the lowest ratio available in the transmission 100.

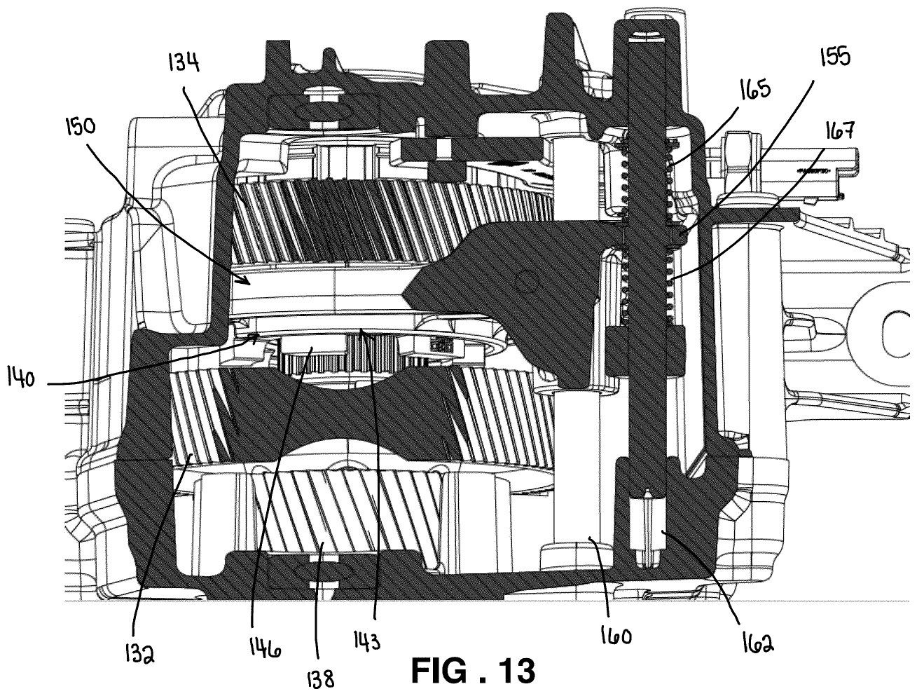

When the operator chooses the high gear shift position with the gear selector, the shift drum 110 is rotated to a high gear rotational position. The transmission 100 is shown arranged in the high gear shift position in FIG. 13. The shift rod 162 is translated to the forward shift rod position along the rod axis 163 by the driving member 170 (as moved by the groove 114). In the forward shift rod position, the shift rod 162 is translated to a forwardmost position. The groove 116 has a wider portion at the high gear rotational position, such that the shift fork 150 can move forward while not being forced forward.

When the projections of the disk 140 and the notches of the high output gear 134 are rotationally aligned, the spring 167 pushes the disk via the shift fork 150 into engagement with the high output gear 134, engaging the disk 140 with the high output gear 132. In the high gear shift position, the low output gear 134 is disengaged from the disk 140 and the parking lever 180 is disengaged from the parking gear 182. Thus, the transmission 100 transfers torque between the input shaft 102 and the output shaft 104 via the high input gear 124 and the high output gear 134. Similarly well-indicated by the name, the high gear shift position is arranged and structured to produce a ratio of the speed of rotation of the output shaft 104 to the speed of rotation of the input shaft 102 that is the highest ratio available in the transmission 100.

The transmission 100 also includes the park shift position (P), where the output shaft 104 is impeded from rotating, which in turn impedes the driveshaft 70 from turning. In the park shift position, the shift drum 110 is rotated to a park rotational position. Additionally, the parking cam 184 is rotated by the shift drum 110 when rotating into the park rotation position, unless misalignment is impeding movement of the parking cam, in which case the parking cam 184 is biased by the spring 188, such that the parking cam 184 pushes the parking lever 180. When the end portion 181 of the parking lever 180 and the notch 183 of the parking gear 182 are aligned, the parking cam 184 pushes the parking lever 180 into engagement with the parking gear 182, engaging the parking gear 182 and the parking lever 180 to prevent rotation of the output shaft 104. When in the park shift position, the high output gear 134 remains engaged with the disk 140, while the low output gear 132 remains disengaged from the disk 140.

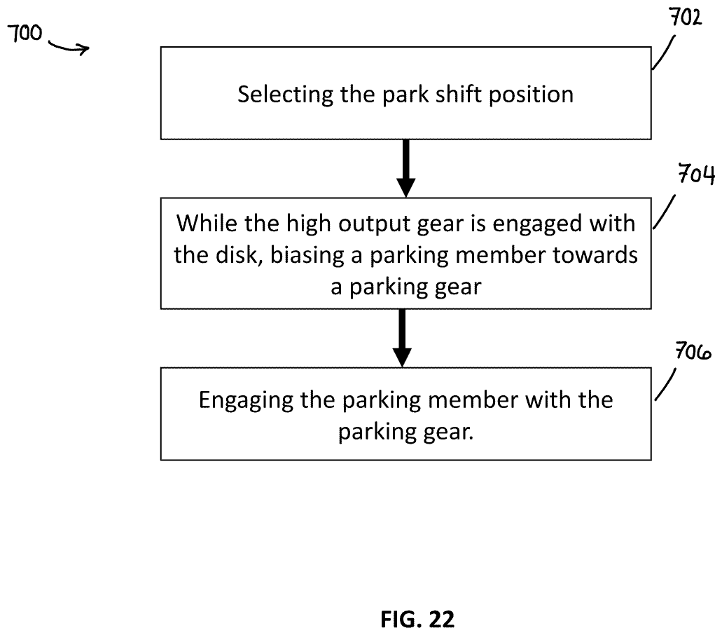

With reference to FIG. 22, a method 700 of parking the vehicle 10 will now be described in detail. For simplicity, the method 700 will be described with the specific example of shifting the transmission 100 from a neutral shift position to the park shift position.

The method 700 begins, at step 702, with selecting the park shift position. In the present embodiment, when the vehicle 10 is at rest, the operator shifts the gear selector lever 80 to the park shift position. The shift drum 110 rotates from the neutral rotational position to the park rotational position which, in turn, moves the transmission 100 from the neutral shift position to the park shift position. As mentioned above, the transmission 100 passes through the high gear shift position before being arranged in the park shift position. That is, as the shift drum 110 rotates, the driving member 170 moves from the neutral portion 199 of the groove 114 to the high output gear portion 196 of the groove 114. In turn, the transmission 100 moves from the neutral shift position, where the disk 140 is disengaged from the low output gear 132 and the high output gear 134, to the high output gear shift position, where the disk 140 is engaged with the high output gear 134. As the shift drum 110 continues to rotate, the drive member 170 moves from the high output gear portion 196 to the park portion 197 of the groove 114. The transmission 100 then moves from the high output gear shift position to the park shift position, where the disk 140 remains engaged with the high output gear 134 as the parking lever 180 is biased towards the parking gear 182 (step 704) and engages with the parking gear 182 (step 706).

In some embodiments, the method 700 may optionally include controlling the electric motor 30, via the motor controller 200, to stop.

To reverse the vehicle 10, the operator has the option to select either a high reverse gear shift position or a low reverse gear shift position. When the operator chooses the high reverse gear shift position, the transmission 100 is arranged in the high gear shift position, as described above, and the motor 30 spins the high output gear 134 in the reverse direction. Similarly, when the operator chooses the low reverse gear shift position, the transmission 100 is arranged in the low gear shift position, as described above, and the electric motor 30 spins the low output gear 132 in the reverse direction.

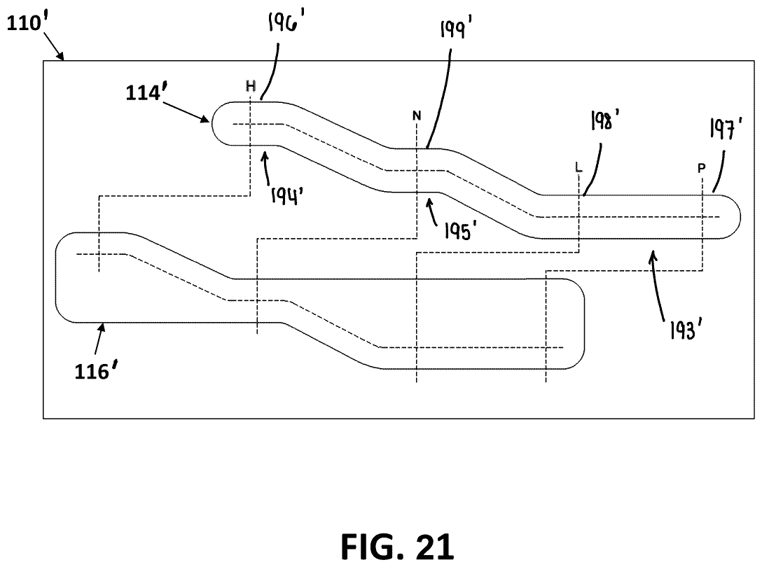

FIG. 21 depicts an alternative embodiment of a shift drum 110′. It is noted that the shift drum 110′ has generally the same configuration as the shift drum 110 (including the grooves 114′, 116′), but differs in the position of the high gear portion 196′ and the position of the low gear portion 198′ and therefore, only the different positioning will be described. In this embodiment, the section 193′ of the groove 114′ includes the low gear portion 198′ and the park portion 197′. The low gear portion 198′, corresponding to the low gear shift position of the transmission 100 and the low gear rotational position of the shift drum 110′, is positioned adjacent to the park portion 197′. The section 195′ of the groove 114′ includes the high gear portion 196′, corresponding to the high gear shift position of the transmission 100 and the high gear rotational position of the shift drum 110′. Thus, when the transmission 100 is in the park shift position, the low output gear 132 is engaged with the disk 140, the high output gear 134 is disengaged from the disk 140, and the parking lever 180 is engaged with the parking gear 182.

The operation of the shift drum 110′ is generally the same as the shift drum 110 but for the low output gear 132 remaining engaged when the parking lever 180 engages the parking gear 182 and thus, will not be described in further detail.

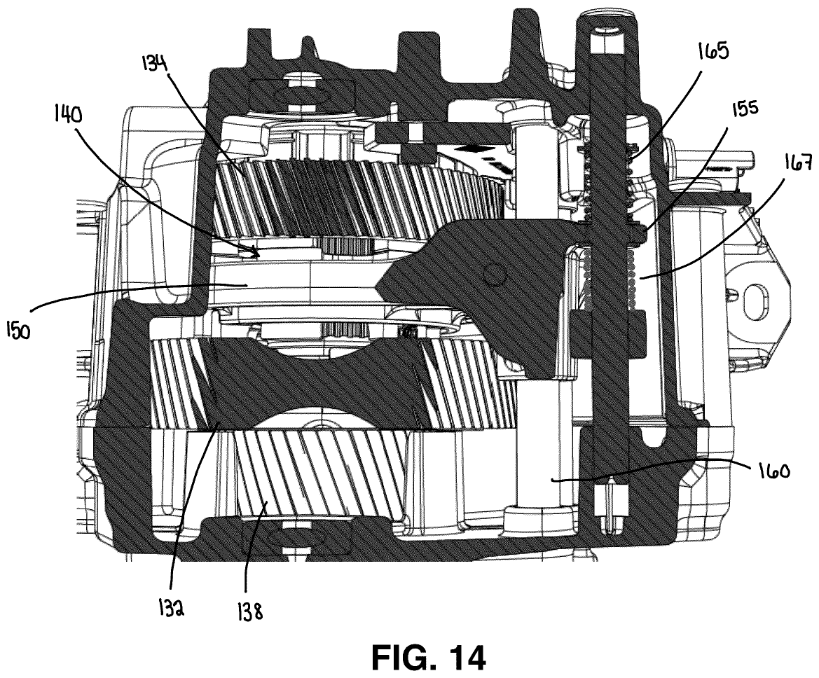

As briefly mentioned above, the vehicle 10 includes the motor controller 200 which is communicatively connected with the motor 30 and the gear shift position sensor 82. The controller 200 is configured to facilitate shifting to the low and high gear shift positions of the vehicle 10, specifically when misalignment of the disk 140 and the output gears 132, 134 occurs (for example, misalignment of the high output gear 134 and the disk 140 is shown in FIG. 14).

Misalignment of the disk 140 and the output gears 132, 134 when shifting may occur. For example, when shifting to the low gear shift position, the projections 146 of the disk 140 may be aligned with the projections 135 of the low output gear 132. In other words, instead of the projections 146 of the disk 140 being received in the notches 136 of the low output gear 132, the outer faces of the projections 146 of the disk 140 abut the outer faces of the projections 135 of the low output gear 132, preventing engagement between the disk 140 and the low output gear 132. The motor controller 200 facilitates the engagement between the disk 140 and the low output gear 132 (corresponding to the lower gear shift position) or the high output gear 134 (corresponding to the higher gear shift position) by aligning the projections of the disk 140 with the corresponding notches of the respective output gear 132, 134 when shifting of the gear shift position of the vehicle 10.

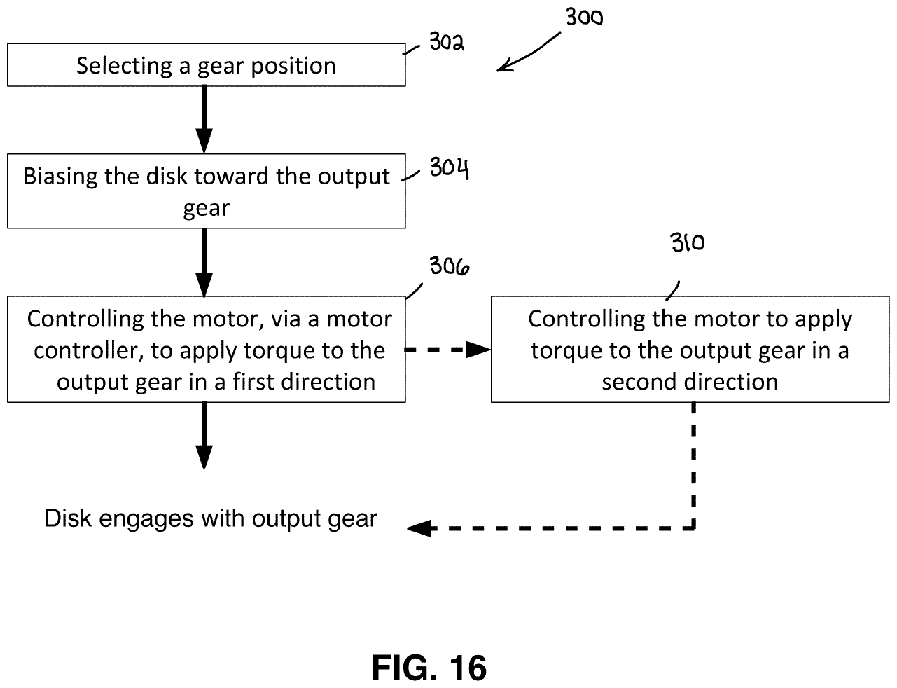

With reference to FIG. 16, a method 300 of shifting to the low or high gear shift position of the vehicle 10 and operation of the motor controller 200 will now be described in detail. For simplicity, the method 300 will be described with the specific example of shifting from the neutral shift position to the low gear shift position. The method 300 and operation of the motor controller 200 with regards to shifting from the neutral shift position to the high gear shift position is identical but for the disk 140 engaging with the high output gear 142 and therefore will not be described in further detail. The order in which the method 300 is described is exemplary and steps may be re-ordered in other embodiments.

The method 300 begins, at step 302, with selecting the low gear shift position. In the present embodiment, when the vehicle 10 is at rest, the operator shifts the gear selector lever 80 to the low gear shift position. The gear shift position sensor 82 detects the rotation of the shift drum 110 and transmits a signal to the motor controller 200, indicating a request to shift gear shift positions to the low gear shift position.

The method 300 continues, at step 304, with biasing the disk 140 towards the low output gear 132. Due to misalignment of the disk 140 and the low output gear 132, the shift fork 150 cannot move within the groove 116. Instead, the spring 165 will be compressed, due to the rearward movement of the shift rod 162, and the spring 167 moves away from the follower 155 of the shift fork 150. In some embodiments, the vehicle 10 includes a motor sensor and a wheel sensor (not shown) in communication with the motor controller 200 to signal the motor controller 200 that misalignment between the disk 140 and the low output gear 132 has occurred. Specifically, the motor sensor would detect the position of the rotor and the wheel sensor would detect motion of at least one of the wheels 14, 18. In the instance of misalignment between the disk 140 and the low output gear 132, the motor sensor would detect a change in the rotor position (that is, the rotor rotating), while the wheel sensor would detect no motion of the at least one of the wheels 14, 18 and in response a signal of misalignment would be transmitted to the motor controller 200. Upon receiving the signal of misalignment, the motor controller 200 sends a stop torque request to the motor 30.

The method 300 continues, at step 306, with controlling the motor 30 to apply a torque to the low output gear 132. Specifically, the motor controller 200 controls the motor 30 to apply the torque to partially rotate the input shaft 102, rotating the input gears 122, 124, thereby rotating the output gears 132, 134. It is to be understood that the motor 30 rotates both the low output gear 132 and the high output gear 134, however for clarity, only the low output gear 132 will be referred to when describing the processes of shifting to the low gear shift position. The motor controller 200 controls the motor 30 to apply the torque in a first direction, such as a forward direction, causing the low output gear 132 to partially rotate in the forward direction.

In some embodiments, when the motor 30 applies the torque, the low output gear 132 may rotate the by an angle substantially equal to a sum of the central angle (denoted by α in FIG. 6) of the projections 146 and the central angle (denoted by θ in FIG. 5) of the projections 135 in the forward direction. In other embodiments, the motor 30 may rotate the low output gear 132 by an angle substantially greater than a sum of the central angle (denoted by α in FIG. 7) of the projections 146 and the central angle (denoted by θ in FIG. 5) of the projections 135 in the forward direction. In some embodiments, the motor controller 200 receives a signal from the motor sensor regarding the position of the rotor, such that the motor controller 200 may precisely control the rotation during application of torque. A specific amount of rotation of the rotor is correlated to a specific amount of rotation of the low output gear, this known relationship can therefore be used to rotate the low output gear 132 by a precise angle.

It is contemplated that in other embodiments, the low output gear 132 may rotate relative to arc length. In this case, when the motor 30 applies the torque, again using the known correlation between rotation of the rotor and rotation of the low output gear, the low output gear 132 may rotate by a distance substantially equal to a sum of the arc length of the projection 135 of the low output gear 132 (denoted by D₁ in FIG. 5) and the arc length of the projection 146 of the disk 140 (denoted by D₃ in FIG. 6). In other instances, the motor 30 may rotate the low output gear 132 by a distance substantially greater than a sum of the arc length of the projection 135 of the low output gear 132 (denoted by D₁ in FIG. 5) and the arc length of the projection 146 of the disk 140 (denoted by D₃ in FIG. 6).

As a result, the projections 146 of the disk 140 align with the notches 136 of the low output gear 132. That is, in response to partially rotating the low output gear 132, the notches 136 eventually coincide with the projections 146 on the disk 140, allowing the notches 136 to receive the corresponding projections 146 and, due to the force exerted by the compressed spring 165, the disk 140 is further biased towards the low output gear 132, engaging the low output gear 132 with the disk 140.

Optionally, the method 300 may include, at step 310, subsequently applying torque and rotating the low output gear 132 in a second, rearward, direction to increase the chances that the low output gear 132 will align and thus, facilitate engagement between the disk 140 and the low output gear 132. In other words, the motor 30 applies a torque in the rearward direction to partially rotate the low output gear 132 in the rearward direction. In some instances, the motor 30 applies the torque in the rearward direction less than one second after applying the torque in the forward direction. In this case, the motor 30 applies the same amount of torque in the forward and rearward direction. In other words, the motor 30 partially rotates the low output gear 132 in the rearward direction by the same amount (that is, the same angle) the low output gear 132 was rotated in the forward direction. It is contemplated that, in some embodiments, the amount of torque applied in the rearward direction may be different than the amount of torque applied in the forward rotation. In these embodiments, due to the bidirectional application of torque, the angle or arc length along which the gear must be rotated in either direction can be limited to the central angle (denoted by α in FIG. 6) of the projections 146 or arc length of the projection 146 of the disk 140 (denoted by D₃ in FIG. 6) which will be sufficient to ensure engagement. It is further contemplated that, in some embodiments, the first direction may be the rearward direction and the second direction may be the forward direction.

In some embodiments, the vehicle 10 may further include a position sensor (not shown) disposed on the shift fork 150 for detecting the position of the shift fork 150. In an alternative embodiment, the position sensor may be disposed on the disk 140. The position sensor may be communicatively connected to the motor controller 200 to transmit a signal, based on the position of the shift fork 150, indicating whether the disk 140 has interlocked with the respective output gear 132, 134. If the motor controller receives a signal that the disk 140 and the output gear 132, 134 did interlock, method 300 may be omitted to avoid unnecessary operations. If the motor controller 200 receives a signal that the disk 140 and the output gear 132, 134 did not interlock, the motor controller 200 may prompt the motor 30 to again apply the torque to initiate another partial rotation of the output gears 132, 134 in the forward direction and/or, in some instances, to prompt the motor 30 to subsequently apply the torque in the rearward direction to partially rotate the output gears 132, 134 in the rearward direction.

As mentioned above, the motor controller 200 is further communicatively connected to the parking lock sensor 190 to facilitate shifting to the park shift position of the vehicle 10, specifically when misalignment between the parking lever 180 and the parking gear 182 has occurred. In response, the motor controller 200 aligns the end portion 181 of the parking lever 180 with one of the notches 182 of the parking gear 182 to facilitate the interlocking between the parking lever 180 and the parking gear 182.

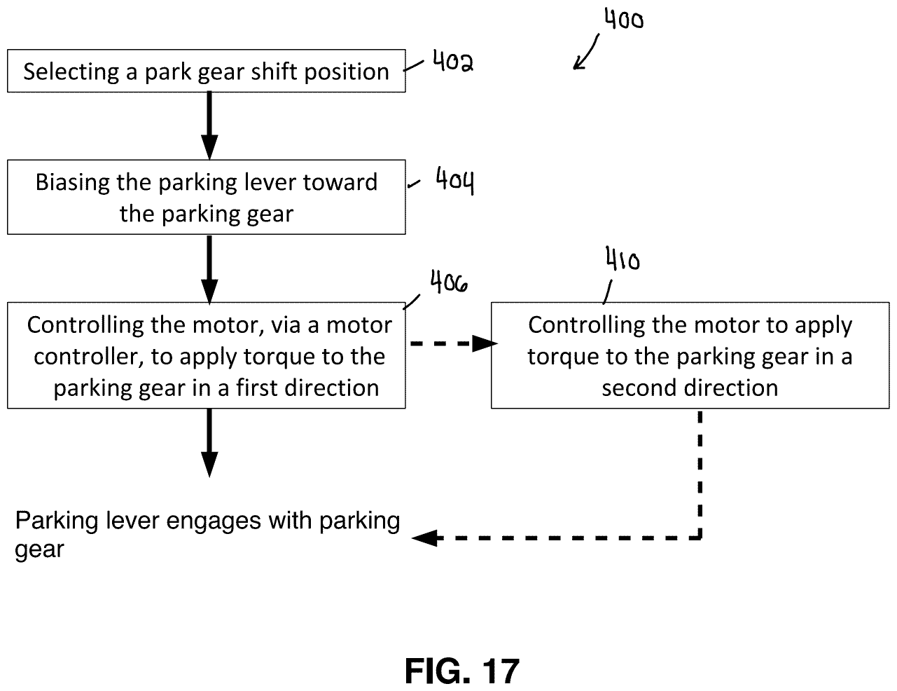

With reference to FIG. 17, a method 400 of shifting the vehicle 10 to the park shift position and the operation of the motor controller 200 when shifting to the park shift position will now be described. It is appreciated that the order in which the method 400 is described is exemplary and steps may be re-ordered in other embodiments.

The method 400 begins, at step 402, with selecting the park shift position. In the present embodiment, when the vehicle 10 is at rest, the operator shifts the gear selector lever 80 to the park shift position.

The method 400 continues, at step 404, with biasing the parking lever 180 towards the parking gear 182. When misalignment of the parking lever 180 and the parking gear 182 occurs, the spring 188 biases the parking lever 180, via the parking cam 184, towards the parking gear 182. The gear shift position sensor 82 detects the change in gear shift positions and transmits a signal to the motor controller 200, indicating the shift to the park shift position. The motor controller 200 further receives a signal from the parking lock sensor 190 indicating the position of the parking lever 180. If the parking lever 180 is still in the disengaged position (as described above), misalignment between the parking lever 180 and the parking gear 182 has occurred.

The method 400 continues, at step 406, with controlling the motor 30 to apply a torque to the parking gear 182. As discussed above, when the transmission 100 is in the park shift position (P), the high output gear 132 is engaged with the disk 140, allowing for rotation of the parking gear 182. Specifically, the motor controller 200 controls the motor 30 to apply the torque to partially rotate the input shaft 102 and the input gears 122, 124 which causes rotation of the output gears 132, 134 and the output shaft 104, thereby rotating the parking gear 182 (which is rotationally fixed to the output shaft 104). The motor controller 200 controls the motor 30 to apply the torque in a first direction, such as a forward direction, causing the parking gear 182 to partially rotate in the forward direction.

In some embodiments, when the motor 30 applies the torque, an outer edge of the teeth 187 may rotate by a distance substantially equal to a sum of a circumferential width of the end portion 181 (denoted by W in FIG. 15) and the arc length of the notches 183 (denoted by L₂ in FIG. 15) in the forward direction. In other embodiments, when the motor 30 applies the torque, an outer edge of the teeth 187 may rotate by a distance greater than a sum of the circumferential width of the end portion 181 (denoted by W in FIG. 15) and the arc length of the notches 183 (denoted by L₂ in FIG. 15) in the forward direction. In some embodiments, the motor controller 200 receives a signal from the motor sensor regarding the position of the rotor such that the motor controller 200 may precisely control the application of torque to rotate the low output gear 132, using the known correlation between rotation of the rotor and rotation of the low output gear.

As a result, the end portion 181 of the parking lever 180 will, at some point during the rotation of the parking gear, align with a notch 183 of the parking gear 182. That is, in response to partially rotating the parking gear 182, a notch 183 of the parking gear 182 coincides with the end portion 181 on the parking lever 180, allowing the notch 183 to receive the end portion 181 and, due to the compressed spring 188, the parking lever 180 is further biased towards the parking gear 182, engaging the parking gear 182 with the parking lever 180.

Optionally, the method 400 may include, at step 410, subsequently rotating the parking gear 182 in a second, rearward, direction to facilitate engagement between the disk 140 and the low parking gear 182. In other words, the motor 30 applies a torque in the rearward direction to partially rotate the parking gear 192 in the rearward direction. In some instances, the motor 30 applies the torque in the rearward direction less than one second after applying the torque in the forward direction. In this case, the motor 30 applies the same amount of torque in the rearward direction as the forward direction. That is, the motor 30 partially rotates parking gear 182 in the rearward direction by the same amount (that is, the same arc length) the parking gear 182 was rotated in the forward direction. It is contemplated that, in some embodiments, the motor 30 may apply a different amount of torque in the forward direction than in the rearward direction. It is further contemplated that, in some embodiments, the first direction may be the rearward direction and the second direction may be the forward direction.

In some embodiments, if the parking lock sensor 190 still indicates that the parking lever 180 and the parking gear 182 did not engage, the motor controller 200 may control the motor 30 to again apply the torque to initiate another partial rotation of the parking gear 182 in the forward direction and/or, in some instances, to prompt the motor 30 to apply the torque in the rearward direction to partially rotate the parking gear 182 in the rearward direction.

In the present embodiment, the motor controller 200 facilitates the disengagement between the disk 104 and the output gears 132, 134 when shifting from one gear shift position to another, specifically in instances where the output gears 132, 134 are applying substantial force onto the disk 140, preventing disengagement. For example, when the vehicle 10 is positioned on a steep incline or decline, the output gears 132, 134 exert increased forces onto the disk 140 which may prevent disengagement between the respective gear 132, 134 and the disk 140, and thus prevents the vehicle 10 from shifting gears.

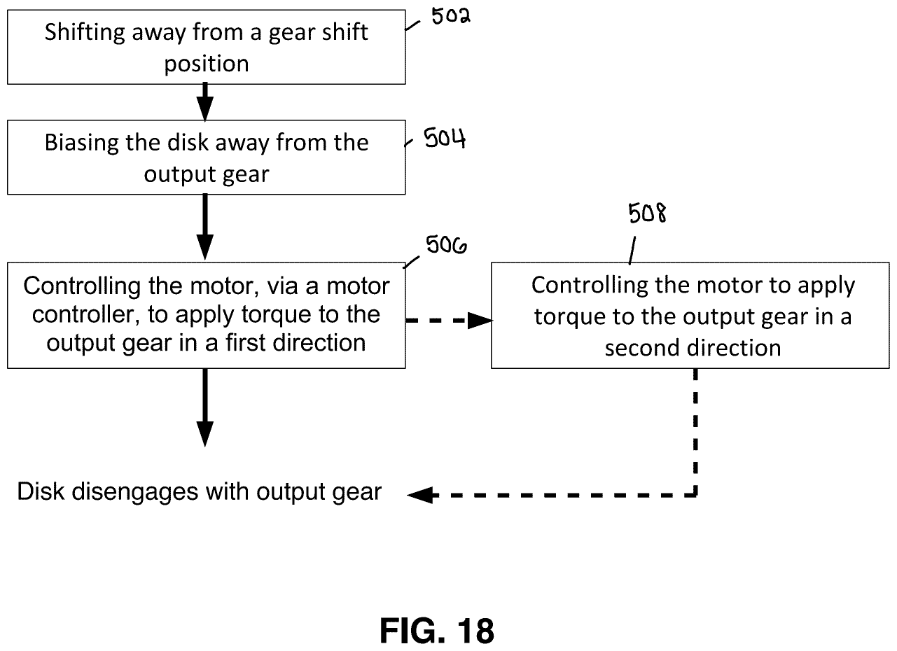

With reference to FIG. 18, a method 500 of disengaging the disk 140 and the output gears 132, 134 will now be described. For simplicity, the method 500 will be described with the specific example of shifting from the low output gear shift position to the neutral shift position. The method 500 and operation of the motor controller 200 with regards to shifting from the high gear shift position to the neutral shift position is identical but for the disk 140 disengaging from the high output gear 142 and therefore will not be described in further detail. It is appreciated that the order in which the method 500 is described is exemplary and steps may be re-ordered in other embodiments.

The method 500 begins, at step 502, with selecting the low gear shift position. In the present embodiment, when the vehicle 10 is at rest, the operator shifts the gear selector lever 80 from the low gear shift position to a different gear shift position (i.e., the high gear shift position). The gear shift position sensor 82 detects the change in gear shift positions and transmits a signal to the motor controller 200, indicating a shift in gear shift position from the low gear shift position.

The method 500 continues, at step 504, with biasing the disk 140 away from the low output gear 132. That is, the shift rod 162 is translated out of the rear shift rod position along the rod axis 163 by the driving member 170 (as moved by groove 114). However, due to the substantial frictional forces between the low output gear 132 and the shift fork 150 is unable to translate. Instead, the spring 167 becomes compressed, due to the forward movement of the shift rod 162, and the spring 165 moves away from the follower 155 of the shift fork.

The method 500 continues, at step 506, with controlling the motor 30 to apply a torque to the low output gear 132. Specifically, the motor controller 200 controls the motor 30 to apply the torque to the input shaft 102, which is transferred to the input gears 122, 124, and thereby transferred to the output gears 132, 134. It is to be understood that the motor 30 applies torque to both the low output gear 132 and the high output gear 134, however for clarity, only the low output gear 132 will be referred to when describing the processes of shifting to the low gear shift position. The motor controller 200 controls the motor 30 to apply the torque in a first direction, such as a forward direction, to cause the friction between the disk 140 and the low output gear 132 to be reduced.

If the vehicle 10 is facing upwards on an incline, the low output gear 132 is applying a rearward force onto the disk 140 which increases the frictional force between them. Thus, when the motor 30 applies the torque to the low output gear 132 in the forward direction, the frictional force between the low output gear 132 and the disk 140 is reduced, thereby facilitating the uncoupling of the low output gear 132 and the disk 140.

If, after applying the torque in the forward direction, the disk 140 and the low output gear 132 are still engaged, such as when the vehicle 10 is instead facing downwards on an incline, the low output gear 132 is applying a forward force onto the disk 140 thereby increasing the frictional force between them. As a result, applying torque in the forward direction would not disengage the disk 140 from the low output gear 132. In this instance, the method 500 continues, at step 508, with subsequently applying a torque in a second, rearward direction to the low output gear 132 to reduce frictional force between the output gear 132 and the disk 140. The motor 30 applies the torque to the low output gear 132 in the rearward direction less than one second after the low output gear 132 applying the torque in the forward direction. In this case, the motor 30 applies the same amount of torque in the forward and rearward direction. It is contemplated that, in some embodiments, the amount of torque applied in the rearward direction may be different than the amount of torque applied in the forward direction. It is further contemplated that, in some embodiments, the first direction may be the rearward direction and the second direction may be the forward direction.

As a result, the projections 146 of the disk 140 uncouple with the notches 136 of the low output gear 132, at some point during application of torque, when the friction between the projections 146 and the projections 136 has been sufficiently reduced. That is, in response to the application of the torque to the low output gear 132 in either the forward or rearward direction, frictional force between the projections 146 of the disk 140 and the projections 135 of the low output gear 132 is reduced to uncouple the disk 140 from the low output gear 132. Upon sufficient reduction of frictional force, the projections 146 may then be separated from the notches 136 of the low output gear 132 and due to the compressed spring 167, the disk 140 is biased further away from the low output gear 132, disengaging the disk 140 from the low output gear 132.

It is contemplated, in alternative embodiments, that the vehicle 10 may include a gyroscope or an inclinometer to detect the slope orientation. In this case, the motor controller 200 may control the motor 30 to partially rotate the output gears 132, 134 in a single direction, which is a direction opposite to that of the slope the vehicle 10 is on.

In alternative embodiments, the vehicle 10 may further include a position sensor (not shown) disposed on the shift fork 150 for detecting the position of the shift fork 150. In an alternative embodiment, the position sensor may be disposed on the disk 140. The position sensor may be communicatively connected to the motor controller 200 to transmit a signal, based on the position of the shift fork 150, indicating whether the disk 140 has disengaged with the respective output gear 132, 134. If the motor controller 200 receives a signal that the disk 140 and the output gear 132, 134 did not disengage, the motor controller 200 may prompt the motor 30 to again perform steps 506 to 508 again.

Similarly, the motor controller 200 facilitates disengagement between the parking lever 180 and the parking gear 182, for example when the parking gear 182 is exerting a substantial force onto the parking lever 180 (i.e., when the vehicle 10 is on a slope as described above), preventing disengagement of the parking lever 180 from the parking gear 182.

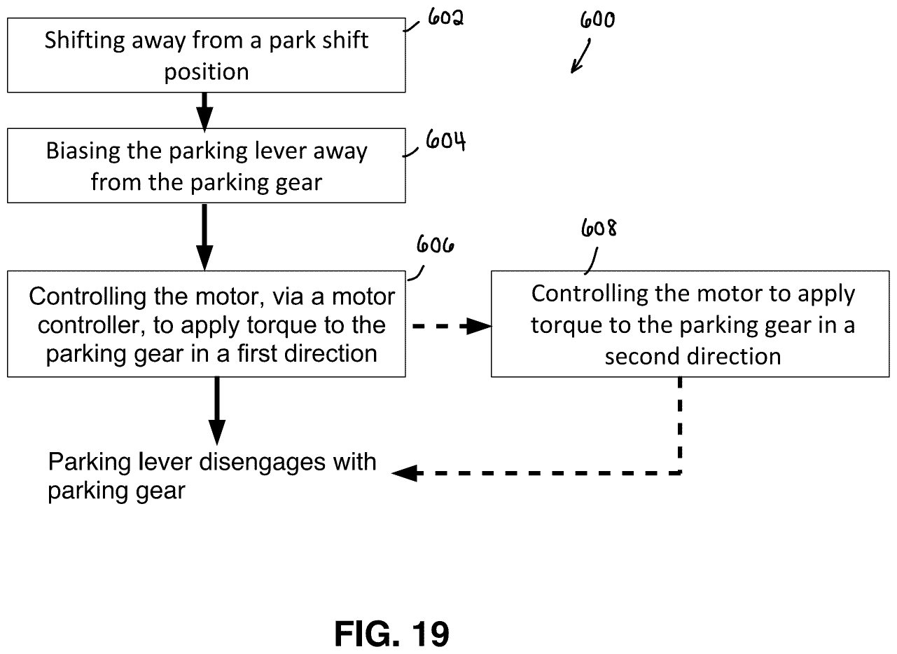

With reference to FIG. 19, a method 600 of shifting the vehicle 10 out of the park shift position and the operation of the motor controller 200 when shifting to the park shift position will now be described. It is appreciated that the order in which the method 600 is described is exemplary and steps may be re-ordered in other embodiments.

The method 600 begins, at step 602, with selecting a different gear shift position, shifting the vehicle 10 out of the park shift position. In the present embodiment, the operator shifts the gear selector lever 80 from the park shift position to a different gear shift position.

The method 600 continues, at step 604, with biasing the parking lever 180 away from the parking gear 182. That is, the spring 186 biases the parking lever 180 away from the parking gear 182. The gear shift position sensor 82 detects the change in gear shift positions and transmits a signal to the motor controller 200, indicating a shift in gear shift position from the park shift position. The motor controller 200 further receives a signal from the parking lock sensor 190 indicative of the position of the parking lever 180. If the parking lever 180 is still in the engaged position (as described above), the parking lever 180 and the parking gear 182 remained interlocked.

The method 600 continues, at step 606, with controlling the motor 30 to apply a torque to the parking gear 182. Specifically, the motor controller 200 controls the motor 30 to apply the torque to the input shaft 102 and the input gears 122, 124 which causes torque to be applied to the output gears 132, 134 and the output shaft 104, thereby applying torque to the parking gear 182. The motor controller 200 controls the motor 30 to apply the torque in a first direction, such as a forward direction, causing the friction between the parking lever 180 and the parking gear 182 to be reduced.

When the motor 30 applies the torque, the parking gear 182 rotates in the forward direction to reduce frictional force between the parking gear 182 and the parking lever 180, thereby facilitating the uncoupling of the parking gear 182 and the parking lever 180 . . .

If, after applying the torque in the forward direction, the parking lever 180 and the parking gear 182 are still engaged, the method 600 continues, at step 608, with subsequently applying a torque in a second, rearward direction the parking gear 182 in the rearward direction. The motor 30 applies the torque to the parking gear 182 in the rearward direction less than one second after applying the torque in the forward direction. In this case, the motor 30 applies the same amount of torque in the forward and the rearward direction. It is contemplated that, in some embodiments, the amount of torque applied in the forward and rearward direction may be different. It is further contemplated that, in some embodiments, the first direction may be the rearward direction and the second direction may be the forward direction.

The method 600 continues, at step 602, with uncoupling the end portion 181 of the parking lever 180 with the notch 183 of the parking gear 182. That is, in response to applying torque to the parking gear 182 in either the forward or rearward direction, frictional force between the end portion 181 of the parking lever 180 and the teeth 187 of the parking gear 182 is reduced to uncouple the parking lever 180 and the parking gear 182. Upon sufficient reduction of frictional force, the notch 183 of the parking gear 182 may then be separated from the end portion 181 of the parking lever 180 and the parking lever 180 is biased further away from the parking gear 182.

It is contemplated, in alternative embodiments, that the vehicle 10 may include a gyroscope or an inclinometer to detect the slope orientation. In this case, the motor controller 200 may control the motor 30 to partially rotate the parking gear 182 in a single direction, which is a direction opposite to that of the slope the vehicle 10 is on.

In some embodiments, the parking lock sensor 190 may transmit a signal to the motor controller 200 to indicate the position of the parking lever 180 (i.e., whether the parking lever 180 is in the engaged position or disengaged position). If the motor controller 200 receives a signal that the parking lever 180 and the parking gear 182 did not disengage, the motor controller 200 may prompt the motor 30 to initiate another application of torque to the parking gear 182 in the first direction and/or, in some instances, to prompt the motor 30 to subsequently perform application of torque to the parking gear 182 in the second direction.

When the motor controller 200 applies torque to the output gears 132, 134 and/or the parking gear 182, it may lead to undesired movement of the wheels 14, 18 of the vehicle 10. For example, undesired movement of the wheels 14, 18 may occur when the motor controller 200 applies torque in the second direction to the output gear 132, 134 (step 310 of the method 300) or the parking gear 182 (step 410 of the method 400), after the output gear 132, 134 has engaged with the disk 140 or the parking gear 182 has engaged with the parking lever 180 following the initial application of torque in the first direction. Alternatively, undesired movement of the wheels 14, 18 may occur during when disengaging the output gear 132, 134 from the disk 140 (the method 500) or the parking gear 182 from the parking lever 180 (the method 600). Thus, to reduce the risk of noticeable wheel 14, 18 movement by the operator during the execution of methods 300, 400, 500, and 600, it is considered that components involved in transferring force from the output shaft 104 to the wheels 14, 18—including but not limited to the output gears 132, 134, the disk 140, the transaxle assembly 33, and the driveshaft 70—may have tolerances loose enough to prevent noticeable wheel movement by the operator. Given the limited rotation and/or applied torque to the output gears 132, 134 and the parking gear 182, the combined tolerances significantly reduce or entirely prevent any motion of the wheels 14, 18 of the vehicle 10 while performing the method 300, 400, 500, 600.

The disclosed embodiments of the vehicle 10 including the motor 30, the transmission 100, and the motor controller 200, minimize frequent engagement and disengagement of the disk 140 and the output gears 132, 134 by maintaining engagement of the disk 140 and the output gear 132, 134 when shifting the transmission 100 into the park shift position. For instance, during travel to a desired location, off-road vehicles often operate in high gear, with the transmission 100 of the vehicle 10 in the high gear shift position, (that is, the high output gear 134 and the disk 140 are engaged). When reaching the desired location, the operator would park the vehicle 10, causing the transmission 100 to shift into the park gear shift position. In the park gear shift position, the parking member 180 engages with the parking gear 182, while the high output gear 134 and the disk 140 remain engaged. To resume travel to a next desired location, the operator would select the high gear. In response, the transmission 100 shifts to the high gear shift position. When moving from the park gear shift position to the high gear shift position, the parking member 180 and the parking gear 182 simply need to disengage, as the high output gear 134 and the disk 140 are already engaged. The reduced frequency of engagement and disengagement between the disk 140 and the output gears 132, 134 provides several benefits including, but not limited to, a reduced likelihood of misalignment between the disk 140 and the output gears 132, 134. This enhances the vehicle 10 responsiveness and provides users with a better user experience. Furthermore, wear of the transmission 100 components, such as the disk 140 and the output gears 132, 134, is reduced, decreasing the amount of degradation of the components. This leads to less maintenance required on the vehicle 10 (i.e., to replace worn or damaged components), and mitigates risk of the disk 140 and the output gears 132, 134 undergoing improper engagement and/or unexpected disengagement during use.

The disclosed embodiments of the vehicle 10 including the motor 30, the transmission 100 and the motor controller 200 to facilitate engagement and disengagement of transmission components while shifting gears provides various benefits including, but not limited to, allowing to minimize the gap between the projections of the disk 140 and the notches of the output gears 132, 134. Specifically, the size of the notches on the output gears 132, 134 may be reduced such that the projections are more closely fitted within the notch, reducing unnecessary (and potentially larger) collisions between the projections of the disk 140 and the projections of the output gears 132, 134 when the disk 140 is engaged with the output gears 132, 134. In some instances, the gap between the projections of the disk 140 and the output gears 132, 134 can be reduced to 4° or less, reducing the impact forces, wear, and noise generated between the disk 140 and the output gear 132, 134, as well as mitigate the risk of unintentional disengagement between the disk 140 and the output gears 132, 134. Additionally, minimizing the gap provides an increase in responsiveness of the vehicle 10 when the accelerator is actuated. Similarly, the gap between the end portion 181 of the parking lever 180 and the projections 187 of the parking gear 182 may be reduced, to help avoid excessive and unwanted movement of the vehicle 10 when placed in the park shift gear position and the operator has released the brake, for example when the vehicle 10 is on an incline. Additionally, the motor controller 200 controlling to motor 30 to partially rotate of the output gears 132, 134 during engagement can help prevent the disk 140 and the output gears 132, 134 from glancing off of each other, in which the projections of the disk 140 collide and bounce off the projections of the output gears 132, 134, thereby mitigating the risk of damage to the disk 140 and the output gears 132, 134. Moreover, the use of the method 300, 400, 500, 600 allows the biasing members 165, 167, 186 and 188, to be designed to apply lower biasing forces, reducing cost and weight of these components. In other vehicles, biasing members 165, 167, 186 and 188 must be sized to overcome significantly higher frictional forces. Specifically, biasing members 165 and 167 must be able to rapidly engage the disk 140 and output gear 132, 134, particularly when the operator is applying maximum torque when accelerating from a standstill. When attempting to engage the parking lever 180 and the parking gear 182, biasing member 186 must exert higher forces on the parking lever 180, to overcome frictional forces between parking lever 180 and the parking gear 182, and biasing member 188 must exert higher forces on the parking cam 184 to overcome the higher opposing force being exerted by biasing member 186.

Modifications and improvements to the above-described embodiments of the present technology may become apparent to those skilled in the art. The foregoing description is intended to be exemplary rather than limiting.

What is claimed is:

1. A method for parking an electric vehicle, the electric vehicle comprising an electric motor operatively connected to a transmission for propelling the electric vehicle, the method comprising:
selecting a park gear shift position; and
while an engagement member of the transmission is engaged with an output gear of the transmission:
biasing a parking member of the transmission towards a parking gear of the transmission; and
engaging the parking member with the parking gear.

2. The method of claim 1, further comprising:
controlling the electric motor, by a motor controller, to stop.

3. The method of claim 1, wherein:
the engagement member is a disk;
the output gear is a high output gear;
the transmission also comprises a low output gear; and
the disk is engaged with the high output gear when biasing the parking member towards the parking gear and engaging the parking member with the parking gear.

4. The method of claim 1, wherein:
the engagement member is a disk;
the output gear is a low output gear;
the transmission also comprises a high output gear; and
the disk is engaged with the low output gear when biasing the parking member towards the parking gear and engaging the parking member with the parking gear.

5. The method of claim 1, wherein:
the parking member is a parking lever; and
biasing the parking member towards the parking gear comprises pivoting the parking lever such that an end portion of the parking lever is received in a notch defined by the parking gear.

6. A transmission for an electric vehicle, the transmission being operatively connected to and driven by an electric motor, the transmission comprising:
a first biasing member;
an output gear operatively connected to the electric motor;
an engagement member operatively connected to the first biasing member to be selectively biased towards and engage the output gear;
a second biasing member;
a parking gear operatively connected to the electric motor; and
a parking member operatively connected to the second biasing member to be selectively biased towards and engage the parking gear; and
the transmission having a park gear shift position, where:
the output gear is engaged with the engagement member; and
the parking gear is engaged with the parking member.

7. The transmission of claim 6, wherein the transmission has an output gear shift position, where:
the output gear is engaged with the engagement member; and
the parking gear is disengaged from the parking member.

8. The transmission of claim 7, wherein:
the output gear is a high output gear;
the transmission further comprises a low output gear; and
the output gear shift position is a high gear shift position.

9. The transmission of claim 7, wherein:
the output gear is a low output gear;
the transmission further comprises a high output gear; and
the output gear shift position is a low gear shift position.

10. The transmission of claim 6, wherein:
the output gear is a first output gear;
the output gear shift position is a first output gear shift position;
the transmission further comprises:
a second output gear operatively connected to the electric motor; and
the engagement member is configured to selectively engage the second output gear.

11. The transmission of claim 10, further comprising:
a shift drum having a surface defining a groove therein, the groove having:
a first section and a second section, the first section being axially offset from the second section, and
the first section having:
a first output gear portion corresponding to the first output gear shift position of the transmission, and
a park portion corresponding to the park gear shift position of the transmission; and
the first biasing member being operatively connected to the groove.

12. The transmission of claim 11, wherein the first output gear portion and the park portion are adjacent to one another within the first section.

13. The transmission of claim 10, wherein the transmission has a second output gear shift position, where:
the second output gear is engaged with the engagement member;
the first output gear is disengaged from the engagement member; and
the parking gear is disengaged from the parking member.

14. The transmission of claim 13, wherein the second section of the groove has a second output gear portion corresponding to the second output gear shift position of the transmission.

15. The transmission of claim 14, wherein:
the first output gear is a high output gear;
the first output gear shift position is a high output gear shift position;
the first output gear portion is a high output gear portion;
the second output gear is a low output gear;
the second output gear shift position is a low output gear shift position; and
the second output gear portion is a low output gear portion.

16. The transmission of claim 14, wherein:
the first output gear is a low output gear;
the first output gear shift position is a low output gear shift position;
the first output gear portion is a low output gear portion;
the second output gear is a high output gear;
the second output gear shift position is a high output gear shift position; and
the second output gear portion is a high output gear portion.

17. The transmission of claim 14, wherein the groove has a third section extending between the first and the second sections, the third section being axially offset from the first and the second sections.

18. The transmission of claim 17, wherein the third section has a neutral portion, corresponding to a neutral shift position of the transmission, where:
the second output gear is disengaged from the engagement member;
the first output gear is disengaged from the engagement member; and
the parking gear is disengaged from the parking member.

19. An electric vehicle comprising:
an electric motor;
a transmission operatively connected to and driven by the electric motor, the transmission having:
a first biasing member;
an output gear operatively connected to the electric motor;
an engagement member operatively connected to the first biasing member to be selectively biased towards and engage the output gear;
a second biasing member;
a parking gear operatively connected to the electric motor; and
a parking member operatively connected to the second biasing member to be selectively biased towards and engage the parking gear; and
the transmission having a park gear shift position, where:
the output gear is engaged with the engagement member; and
the parking gear is engaged with the parking member;
a driveshaft operatively connected to and driven by the electric motor via the transmission; and
at least one ground engaging member operatively connected to and driven by the drive shaft.

20. The electric vehicle of claim 19, further comprising a motor controller in communication with the electric motor and configured to stop the electric motor in response to the transmission being in the park gear shift position.
